(19) United States
(12) Patent Application Publication
(10) Pub. No.: US 2004/0225564 A1
(43) Pub. Date: Nov. 11, 2004

(54) Systems and methods for providing an in-store media broadcast

(76) Inventors: Stuart Walsh, Idaho Falls, ID (US); Kent Kvarfordt, Idaho Falls, ID (US); Linwood Register, Marietta, GA (US); Robert Powell, Idaho Falls, ID (US)

Correspondence Address: KIRTON & McCONKIE, 1800 Eagle Gate Tower, 60 East South Temple, Salt Lake City, UT, 84111, US

(21) Appl. No.: 10/770,810

(22) Filed: Feb. 3, 2004

Related U.S. Application Data
(63) Continuation-in-part of application No. 10/145,920, filed on May 15, 2002.
Application No. 10/145,920 is a continuation-in-part of application No. 10/146,192, filed on May 15, 2002.

(51) Int. Cl. G06F 17/60

(52) U.S. Cl. 705/14

(57) ABSTRACT

Systems and methods for providing customizable music, advertisements and/or other content to a remote business or retail location. One or more player devices are configured to selectively broadcast customizable music, advertisements and/or other content at remote business locations. A system, architecture or interface is used to deliver the customizable music and/or advertisements to the remote retail locations for the broadcast. The player devices are each located in a retail location and may be grouped according to retail chains or any other common characteristic between the retail locations, the content broadcast, etc. Optionally, a chain manager oversees or manages the content that is broadcast at a particular group of player devices. The content may be customized to particular retail chains/groupings, to neighborhood environments, business types, etc.

### Related Applications

This application is a continuation-in-part of U.S. patent application Ser. No. 10/145,920 filed May 15, 2002, entitled SYSTEM FOR AND METHOD OF DOING BUSINESS TO PROVIDE NETWORK-BASED IN-STORE MEDIA BROADCASTING and U.S. patent application Ser. No. 10/146,192 filed May 15, 2002, entitled PROVIDING A MULTI-TIER ENTERPRISE LEVEL APPLICATION. Both applications are incorporated herein by reference.

### BACKGROUND OF THE INVENTION

1. Field of the Invention

The present invention relates to providing a customizable in-store media broadcast. In particular, the present invention relates to systems and methods for providing customizable music, advertisements and/or other content to a remote business or retail location.

2. Background and Related Art

Some businesses provide background music to create a more inviting and relaxed atmosphere. The music is provided through an audio system installed at the business location that allows the music to be heard throughout the business location. At times, the music may be interrupted to broadcast an announcement to customers at the business location.

The music provided throughout the business location may be used not only at that business location, but also at other locations through a provider specializing in the broadcasting of music to businesses. This service has been provided through a satellite based broadcast system, wherein the satellite is uploaded with a play list, which is sent down to a receiver located at the business location. The play list can then be pulled from the receiver and directed through an audio system installed in the business location.

Although music is provided through the available service, there are several inherent difficulties and limitations with the service. First, the music broadcast is limited by an expensive and unaccommodating satellite infrastructure. The information uploaded to the satellite and then burst down to the satellite receivers is uniform, meaning that each receiver receives the same play list or the same advertisement or the same announcement. As such, each merchant or service provider is forced to provide through their business location the same broadcast as the next merchant or service provider. This inflexibility has severely limiting effects in that a merchant is unable to control the broadcast. Further, the merchant or service provider may be forced to interrupt the broadcast to advertise or announce those items that would be of particular interest to those visiting the particular business location. For example, if a merchant wanted to broadcast an advertisement for one week at a certain time that promoted a sale, the merchant would be forced by current systems to interrupt the normal broadcast.

Second, there is no way to update the broadcast at will as the merchant or service provider must wait until the next scheduled download from the satellite system.

Third, the method used to provide the broadcast information is limiting and burdensome to the individual merchants or service providers. Merchants and service providers spend literally millions of dollars a year to receive a broadcasting service like the one described above. As this is an added expense, this type of broadcasting service directly impacts and reduces overall profit margins. Moreover, the satellite-based system does not allow for each business location to customize their broadcast and receive updates as desired. Still further, this service does not serve as a revenue generating source for the business location, but is instead an added expense. Still further, as a franchising operation it is difficult to control the distribution system, thus making it difficult to implement any advertising sales strategy or to become affiliated with various businesses for the purpose of advertising.

Thus, while techniques currently exist that are used to provide a broadcast in a business location, challenges still exist, including little to no customization of the broadcast. Accordingly, it would be an improvement in the art to augment or even replace current techniques with other techniques.

### SUMMARY OF THE INVENTION

The present invention relates to providing a customizable in-store media broadcast. In particular, the present invention relates to systems and methods for providing customizable music, advertisements and/or other content to a remote business or retail location.

Implementation of the present invention takes place in association with one or more player devices that are configured to selectively broadcast customizable music, advertisements and/or other content at remote business locations. A system, architecture or interface is used to deliver the customizable music and/or advertisements to the remote retail locations for the broadcast. The player devices are each located in a retail location and may be grouped according to retail chains or any other common characteristic between the retail locations, the content broadcast, etc. Optionally, a chain manager oversees or manages the content that is broadcast at a particular group of player devices. The content may be customized to particular retail chains/groupings, to neighborhood environments, business types, etc.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 illustrates a representative computer device for use in association with at least some embodiments of the present invention;

FIG. 2 illustrates a representative system that provides a suitable operating environment for embodiments of the present invention;

FIG. 3 illustrates a representative system configuration that may be used in accordance with an embodiment of the present invention that provides an architecture and interface for delivering customizable music and advertisements to remote retail locations;

FIG. 4 is a flowchart that provides representative processing at a client player device in accordance with the embodiment of FIG. 3;

FIG. 5 is a flowchart that illustrates obtaining customizable content and broadcasting the customized content at a business location;

FIG. 6 is a flowchart that provides representative processing relating to formatting broadcast content; and

FIG. 7 is a flowchart that provides representative processing relating to contracts, advertisements and schedules.

### DETAILED DESCRIPTION OF THE INVENTION

The present invention relates to providing a customizable in-store media broadcast. In particular, the present invention relates to systems and methods for providing customizable music, advertisements and/or other content to a remote business or retail location.

Embodiments of the present invention takes place in association with one or more player devices that are configured to selectively broadcast customizable music, advertisements and/or other content at remote business locations. A system, architecture or interface is used to deliver the customizable music and/or advertisements to the remote retail locations for the broadcast. The player devices are each located in a retail location and may be grouped according to retail chains or any other common characteristic between the retail locations, the content broadcast, etc. Optionally, a chain manager oversees or manages the content that is broadcast at a particular group of player devices. The content may be customized to particular retail chains/groupings, to neighborhood environments, business types, etc.

The following disclosure of the present invention is grouped into two subheadings, namely “Exemplary Operating Environment” and “Providing an In-Store Media Broadcast.” The utilization of the subheadings is for convenience of the reader only and is not to be construed as limiting in any sense.

### Exemplary Operating Environment

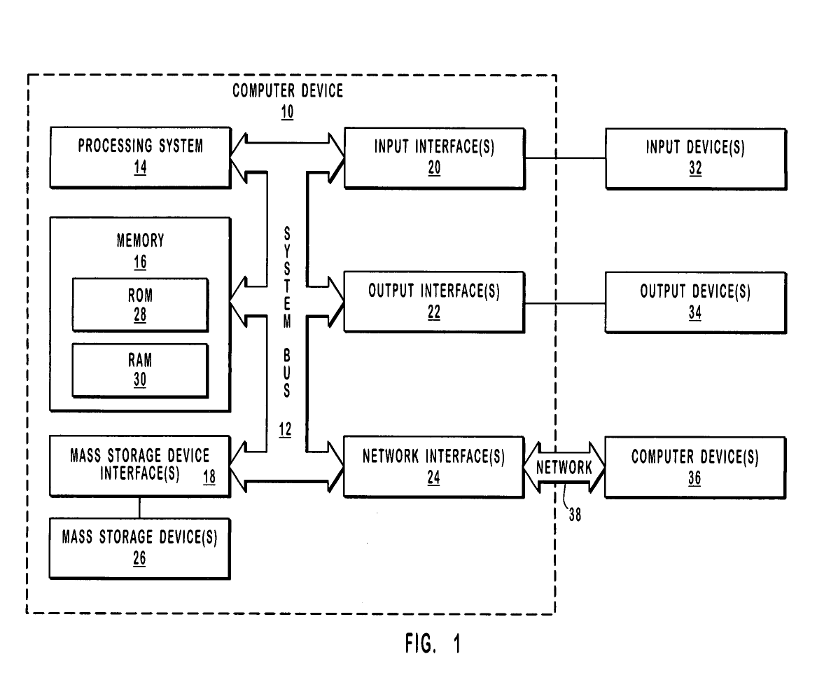

At least some embodiments of the present invention take place in association with one or more computer devices that are configured for utilization in association with providing an in-store media broadcast. Accordingly, FIG. 1 and the corresponding discussion are intended to provide a general description of a computer device. One skilled in the art will appreciate that the invention may be practiced by one or more computer devices and in a variety of configurations, including networked configurations.

Some embodiments of the present invention embrace one or more computer readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

With reference to FIG. 1, a representative system for implementing the invention includes computer device 10, which may be a general-purpose or special-purpose computer. For example, computer device 10 may be a personal computer, a notebook computer, a personal digital assistant (“PDA”) or other hand-held device, a workstation, a minicomputer, a mainframe, a supercomputer, a multi-processor system, a network computer, a processor-based consumer electronic device, such as a receiver or other processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer readable media, such as on memory 16, a magnetic hard disk, a removable magnetic disk, a magnetic cassette, an optical disk, or from a communication connection, which may also be viewed as a computer readable medium.

Memory 16 includes one or more computer readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), a firewire (IEEE 1394), or another interface.

One or more output interfaces 22 may be employed to connect one or more corresponding output devices 34 to system bus 12. Examples of output devices include a monitor or display screen, a speaker, a printer, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

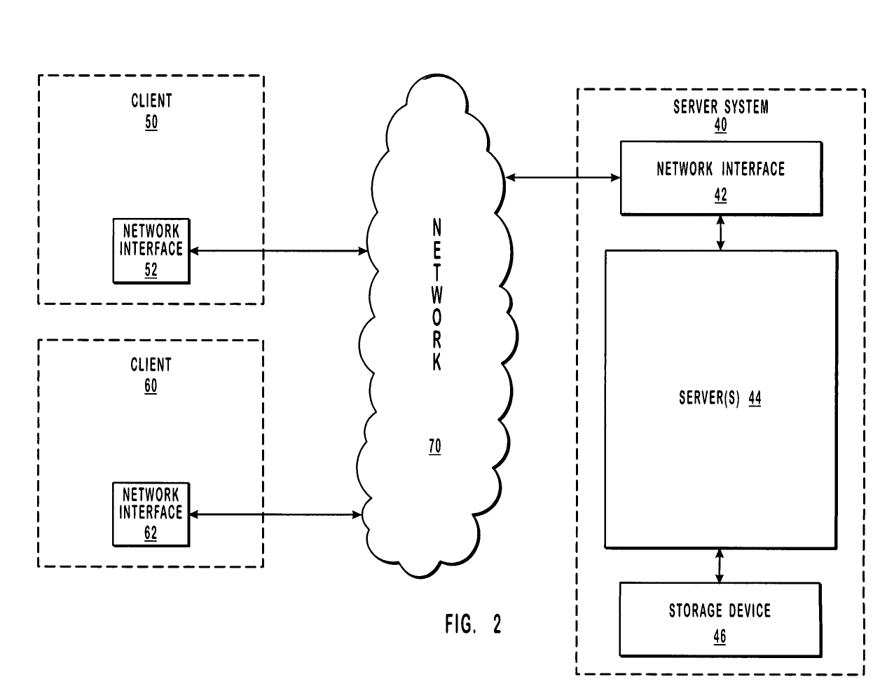

While those skilled in the art will appreciate that embodiments of the present invention may be practiced in a variety of computing environments with many types of computer system configurations, FIG. 2 provides a representative configuration that includes two clients connected to a server system. Those skilled in the art will appreciate that alternative embodiments include one client connected to a server system, more than two clients connected to a server system, a peer-to-peer system configuration, radio technology, satellite technology, a variety of computer media technology, and the like. Moreover, some embodiments in accordance with the present invention include a multitude of clients throughout the world connected to a network, where the network is a wide area network, such as the Internet.

As provided above, embodiments of the present invention take place in association with one or more player devices that are configured to selectively broadcast customizable music, advertisements and/or other content at remote business locations. A system, architecture or interface is used to deliver the customizable music and/or advertisements to the remote retail locations for the broadcast. By way of example, a system configuration is illustrated in FIG. 2 that includes a clearinghouse or server system 40 connected to clients 50 and 60 via a network 70. Those skilled in the art will appreciate that network 70 may include a wide area network (e.g., the internet), a local area network, a leased line connection, a wireless network, a dial up connection, a satellite connection, a radio connection and/or any other type of connection that enables information to be exchanged between system 40 and clients 50 and 60.

System 40, client 50, and client 60 each include a network interface (respectively illustrated as network interfaces 42, 52, and 62) that enables information to be exchanged or communicated. In the illustrated embodiment, system 40 also includes one or more servers 44 that selectively manage data, which is preserved at and/or obtained from a storage device 46. Customizable media content is dynamically provided to clients 50 and 60 for in-store media broadcasts at each client, wherein the broadcast content is customized to particular retail chains/groupings, to neighborhood environments, business types, individual businesses, etc.

### Providing an In-Store Media Broadcast

As provided above, embodiments of the present invention relate to providing a customizable in-store media broadcast. In particular, embodiments of the present invention relates to systems and methods for providing customizable music, advertisements and/or other content to a remote business or retail location.

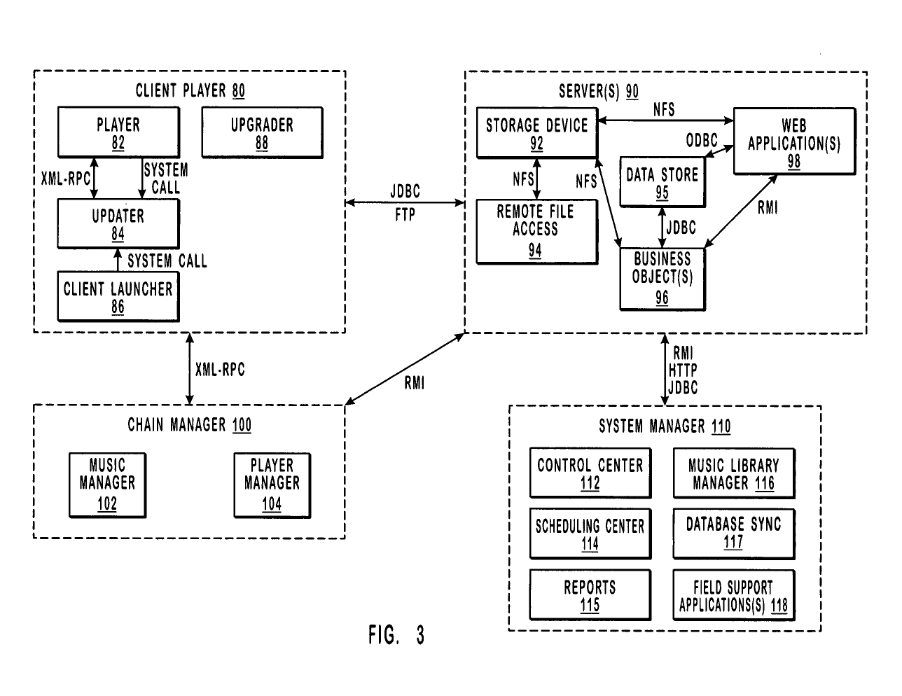

With reference now to FIG. 3, a representative system configuration is illustrated that may be used in accordance with an embodiment of the present invention to provide an architecture and interface for delivering customizable music and advertisements to remote retail locations. FIG. 3 includes four components, namely client player 80, one or more servers 90, a chain manager 100, and a system manager 110.

In one embodiment, servers 90 include application and database servers and file storage devices to manage one or more resources. Servers 90 communicate with the other components of the framework using, for example, Java Database Connectivity (hereinafter “JDBC,” which is a application program interface that enables Java programs to access database information and translates data queries into commands that the database management system understands), File Transfer Protocol (hereinafter “FTP,” which is a protocol used in association with the Internet for sending files), Remote Method Invocation (hereinafter “RMI,” which is a set of protocols developed for Java objects that enables the protocols to communicate remotely with other Java objects), and Hypertext Transfer Protocol (hereinafter “HTTP”).

Client player 80 includes applications that run on client computers located in remote locations, such as in particular stores of a retail chain. The applications play and log in-store music and advertisements, connect to the server(s) 90 for updates, and upgrade software and music on the client. Client player 80 communicates with servers 90, for example, using JDBC and FTP. Further, client player communicates with chain manager 100 using Extensible Markup Language—Remote Procedure Call (hereinafter “XML-RPC,” which is a protocol that allows a program on one computer to execute a program on a server computer, wherein a client program sends an Extensible Markup Language (XML) message to the server with appropriate arguments and the server returns a message containing the results of the program executed). In one embodiment, client player is a headless computer device.

Communication between client player 80 and server 90 is based on the TCP/IP protocol. Embodiments of the present invention embrace a variety of configurations for communication between a client player and a server. For example, in one embodiment, a client player and server communicate via the public Internet. In another embodiment, a client player and server communicate via a direct network connection. In yet another embodiment, a client player and server communicate via a dial-up connection. Those skilled in the art will appreciate that embodiments of the present invention embrace a variety of different communication configurations to enable a plurality of client player computer devices to communicate with one or more servers.

System manager 110 includes a suite of tools developed to automate business functions, such as creating and modifying contracts, advertisements, and schedules. Some applications provide reports to track the status of business functions. System manager 110 communicates with server(s) 90 using RMI, HTTP, and JDBC.

Chain Manager 100 includes a suite of tools developed for use by retail chain personnel or by a manager of a grouping of one or more client players to manage music and control client players. A chain is a grouping or association of locations at which a client player resides. The chain manager provides authority of a representative of a particular chain, grouping, or association of client players to manage the content broadcast at the individual players. In one embodiment, chain manager 100 is a computer device that resides at a nearby location to client player 80. In another embodiment, chain manager 100 resides at a remote location to client player 80. Chain manager 100 communicates with client player 80 using XML-RPC and with server(s) 90 using RMI. Embodiments of the present invention embrace the elimination of chain manager 100, whereby, for example, the functionality and control discussed below in relation with chain manager 100 is performed by system manager 110.

In the illustrated embodiment, server(s) 90 includes storage device 92, remote file access 94, data store 95, business objects 96, and application(s) 98. Storage device 92 includes a computer readable medium having accessible resources and/or files preserved thereon. For example, storage device 92 includes one or more physical storage devices (e.g., hard disk drives, tape drives, and optical disk drives) to hold files (e.g., audio and video files) that are to be provided to a client player computer.

Remote file access 94 includes one or more servers (e.g., an FTP server) to provide a means for transferring files (e.g., audio and/or video files) to client player 80. In the illustrated embodiment, remote file access component 94 communicates with storage device 92 using a network file system (hereinafter “NFS,” which is a client/server application that allows users to access shared files stored on computers of different types through an interface referred to as a virtual file system or VFS that runs on top of TCP/IP protocol).

Business object(s) component 96 comprises a layer that models and enforces business rules and/or data of an organization. In the illustrated embodiment, business object(s) 96 communicates with storage device 92 using NFS, with data store 95 using JDBC, and with applications 98 using RMI.

Data store 95 comprises a business data layer that models and enforces business rules and/or data of an organization, and includes music, advertisements, field services, chain, contract, and schedule information. In the illustrated embodiment, data store 95 communicates with business objects 96 using JDBC and with web applications 98 using Open Database Connectivity (hereinafter “ODBC,” which is a database access method that makes it possible to access any data from any application, regardless of which database management system is handling the data by translating the application data queries into commands that the database management system understands). In one embodiment, data store 95 comprises flat XML files.

In another embodiment, data store 95 comprises one or more databases, such as an enterprise database, a music library database, and a field services database. Updater 84, control center 112, scheduling center 114, reports 115, database sync 117, field support application 118, and music manager 102, each of which will be discussed below, use information in the enterprise database. Reports 115 and field support application 118, each of which will be discussed below, use information in the field services database. Reports 115 and music manager library 116, each of which will be discussed below, use information in the music library database.

Web applications 98 interact with business information/objects (e.g., stored procedures) to perform functions in the system. For example, web applications 98 include multiple applications that are the web accessible presentation to business objects 96 and data store 95. Those skilled in the art will appreciate that embodiments of the present invention also embrace non-web based applications for use in accordance with the present invention.

Web applications 98 include both web-based reports and applications utilized by non-chain managers to manage business functions (e.g., contract and advertisement management) and to view business information (e.g., connection reports). In the illustrated embodiment, web applications 98 communicate with file storage 92 using NFS, with data store using ODBC, and with business objects 96 using RMI.

In the illustrated embodiment, client player 80 is a computer device that includes player 82, updater 84, client launcher 86, and upgrader 88. Player 82 includes an application that creates a schedule for playing/broadcasting advertisements and media files (including announcements), selectively chooses media files to play/broadcast, plays media files, and logs advertisements and media files that have been played/broadcast along with any errors that occurred. In one embodiment, player 82 includes an XML-RPC server and an audio dynamic range compressor/expander for leveling the volume of media files. Player 82 communicates with updater 84 using XML-RPC and invokes updater 84 via system calls. Player 82 also communicates with player manager 104 of chain manager 100 via XML-RPC.

In one embodiment, player 82 includes a scheduler, a media playback framework, an event log manager, an XML-RPC server, a volume fader, and a dynamic range compressor/expander. In the illustrated embodiment, the scheduler selects a media file randomly from weighted genres specified in the playlist in the following manger: (1.) Genres are assigned a range of numbers between 1 and 100 reflecting their weight, for example, if two genres are specified in the playlist with weights of 70 and 30, respectively, the first genre is assigned a range of 1-70 and the second genre is assigned a range of 71-100; (2.) A random number, between 1 and 100, is generated to determine the genre that is selected, therefore in the present example, a random number of 75 would result in the selection of the second genre; and (3.) Media files in the genre folders are marked as either “played” or “not played,” and a random number, between 1 and the number of files in the “not played” category, is generated to determine the media file to be selected. Accordingly, a random number of 235 would result in the selection of the 235^{th} file in the genre folder that has a “not played” status.

The scheduler ensures that no two media files of the same artist are played back-to-back. It remembers the name of the artist of the last media file played and will randomly select another file from the “not played” list. It will repeat this process up to three times if it keeps selecting the same artist. The media framework plays the selected file and the file is marked as played so that it will not be played again until all of the files in that genre have played. Accordingly, if any changes are made to the playlist, all files will be reset to “not played”.

The scheduler also determines which advertisements need to be played and the determination is performed in the following manner: (1.) The scheduler evenly spaces advertisements throughout the hour, assigning an exact play time for each advertisement; (2.) It determines if an advertisement needs to be played at the completion of each media file that is played, and if one or more of the advertisement play times fall between the time of the current check and the last check, those advertisements are selected for play; and (3.) After the check has been completed the scheduler records the time it performed the check as the “last check”. (At startup the “last check” is set as the current time.) The media framework plays the selected advertisement(s). In a further embodiment, the advertisements do not clean themselves out at the top of the hour, so if an hour is overscheduled, all of the advertisements will play (one right after the other) then a media file will play and the next set of scheduled advertisements will play. The log manager records all media files and advertisements played, along with their associated playback timestamps and any errors that may have occurred.

The XML-RPC server allows an XML-RPC client program to connect to the player and perform certain functions. This connection requires authentication by the client program. The functions supported by the XML-RPC server include retrieving advertisement-played information, viewing scheduled advertisements, stopping scheduled advertisements for a period of time, logging errors, viewing and/or deleting log entries, getting and/or setting a volume level, viewing a list of media files that have played and when they played, skipping a currently playing media file, moving a media file to a different genre, deleting a media file, launching updater 84, starting player 82 if the player is listening for requests, stopping player 82 to leave the player listening for requests, shutting down player 82 so that the player stops listening for requests, shutting down the box (with a reboot if desired), querying the status of player 82, etc.

The Dynamic range compressor/expander is a volume leveler that modifies the output of media files, leaving advertisements in their original state. This provides the functionality to allow advertisements to run a little “hotter” than media files. The volume fader fades the volume of a song after a configurable duration. This provides the functionality to create short music programs.

Updater 84 comprises an application that uploads advertisements played, music versions, and software version information to the server(s) 90, receives new connection times from server(s) 90, gets new playlists from server(s) 90, and downloads any files referenced in the playlists. In the illustrated embodiment, updater 84 communicates with player 82 using XML-RPC and is invoked by player 82 and client launcher 86 via system calls. Updater 84 communicates with remote file access 94 of server(s) 90 via FTP and with data store 95 of server(s) 90 via JDBC.

In a further embodiment, the server calls for updater 84 include open connection, insert connection record, get new connectivity information, upload advertisement-played information from player 82 via an XML-RPC connection, get new playlist information, get a list of advertisements for client player 80 and determine which advertisements need to be downloaded, remove advertisements from client player 80 that are not referenced in the current playlist, downloading advertisements by getting FTP login information, looping through advertisements to download, cleaning up advertisement inconsistencies to ensure that the server knows which advertisements the client player has and to ensure that the server information is consistent with the client information, updating the connection record, closing the connection, and logging any errors that occur.

Client launcher 86 comprises an application that launches updater 84 either at the scheduled time or on demand, and includes connectivity specific programs such as a ring-daemon (which listens for incoming calls), a connection establisher, and an IP address poster. In the illustrated embodiment, client launcher 86 invokes updater 84 via system calls.

In one embodiment, client launcher 86 launches at the connect day and time specified in a configuration file that is selectively updated. Further, client launcher includes the following capabilities for dial-up configurations: First, for every execution of updater 84, client launcher 86 initiates a dial-up connection, handling authentication and addressing, logging errors, and connecting within a configurable time duration. Second, client launcher 86 includes an ability to launch updater 84 on demand. For example, this is accomplished via a ring-daemon that listens for an incoming call, clears the line, and executes updater 84.

Upgrader 88 comprises an application that upgrades software and/or media files on client player 80. In the illustrated embodiment, upgrader 88 does not communicate with any other client player application. In a further embodiment, the application also logs its status, handles error conditions, supports versioning of music and/or software, and will not run an upgrade that is at or below the current version on the system.

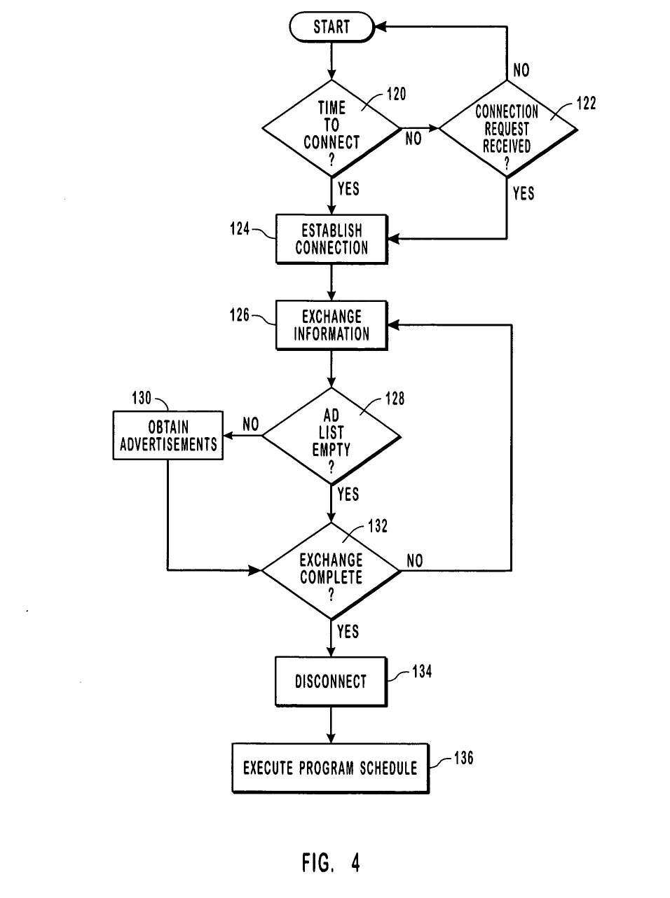

With reference now to FIG. 4, a flowchart illustrates representative processing at a client player device, such as client player 80 of FIG. 3, which is performed by a player, and updater, and a client launcher. In FIG. 4, execution begins at decision block 120, where a determination is made as to whether or not it is time to make a connection. In the present embodiment, the client player device initiates contacts with the clearinghouse or server system at predetermined times and if it is determined at decision block 120 that it is not time to make the connection with the server system, execution proceeds to decision block 122 for a determination as to whether or not a connection request has been received.

In one embodiment, the client software includes an on-demand application for dialup. Accordingly, a technician calls the phone number associated with the client (e.g., a Linux box) and then hangs up. The modem monitor hears the call, clears the line, and dials into the ISP to establish a connection to the Internet. Through this Internet connection, the IBN server is contacted and the client's IP address is posted. After processing is completed, the technician can use the IP address to connect to the client box if necessary. Thus, if it is determined at decision block 122 that a connection request has not been received, execution returns back to start. However, if it is determined at decision block 122 that a connection request has been received, execution proceeds to step 124.

Returning back to decision block 120, if it is determined that it is time to make a connection with the clearinghouse or server system, execution proceeds to step 124, where the connection is established between the client player device and the clearinghouse system. At step 126, information is exchanged. The exchanged information may include, for example, reports as to when and what was broadcast at the client, desired playlists, and other useful information. Accordingly, the exchanged information may be from the client to the server system and/or from the clearinghouse or server system to the client. Execution then proceeds to decision block 128 for a determination as to whether or not an advertisement list is empty.

In one embodiment, an empty advertisement list exchanged at step 126 indicates that no advertisements are to be obtained at this time. Accordingly, if it is determined at decision block 128 that the advertisement list is empty, execution proceeds directly to decision block 132. However, if the advertisement list is not empty, execution proceeds to step 130 to obtain the advertisements, such as by utilizing an FTP connection. Execution proceeds to decision block 132.

At decision block 132, a determination is made as to whether or not the exchange is complete. If it is determined at decision block 132 that the exchange is complete, execution proceeds to step 134. Alternatively, if it is determined at decision block 132 that the exchange is not complete, execution returns back to step 126 for the exchange of additional information. This process continues until the information exchange is complete. The client then disconnects from the server system at step 134 and the new program schedule is executed by the client at step 136.

With reference back to FIG. 3, the illustrated embodiment also includes system manager 110, which comprises control center 112, scheduling center 114, reports 115, music library manager 116, database sync 117, and field support application(s) 118. A non-chain manager utilizes one or more of these tools to perform the high-level management functions. Embodiments of the present invention embrace the suite of tools residing on one or more computer devices at one or more locations.

Control center 112 is a tool that creates and maintains chain information, store information, group information, music configuration, user information, advertising category information, and the like. It also manages date and time sensitive music playlists for chains, groups, and stores as well as overseeing user privileges. By way of example, a playlist includes a media component (a music playlist) that specifies one or more music genres, such as country, classic, Christmas, jazz, etc., weighted by a percent for playback at a scheduled dates and times, and an advertising component (an advertisement playlist) that specifies zero or more advertisements for playback at scheduled dates and times. The control center 112 manages the media component of the playlist. Control center 112 communicates with business object(s) 96 of server(s) 90 via RMI.

In one embodiment, the control center includes the capability to create, edit and/or delete music configurations, advertising categories, a contact person or system user, store chains, store groups, stores, a default music playlist, and/or a date/time specific music playlist. Further the control center includes the capability to set user privileges for system users, assign a contact person to a store chain, assign stores to store groups, set the number of times in-store and revenue advertisements play in a store (referred to as “slots”), set the volume level for the client player computer for a specific store, assign a contact person to a store, set connectivity information for a store (either networked or dial-up), and assign stores to a playlist.

Scheduling center 114 is a tool that manages in-store contracts, revenue contracts, business contacts, advertisements, the scheduling of advertisements to contracts, etc. Scheduling center 114 communicates with web application(s) 98 of server(s) 90 via HTTP.

In one embodiment, scheduling center 114 is an application that manages the lifecycle of contracts and advertisements. In relation to contracts, it creates, edits, and submits for approval pending revenue and/or in-store contracts. It also specifies stores, dates, exclusivity, advertising categories, and slots for contracts. Moreover, it resolves conflicts between contracts, views contracts in any status of their lifecycle, approves contracts, activates contracts, and manages sales contacts. In relation to advertisements, it creates, edits, and/or deletes an advertisement placeholder, which includes information relating to a specific advertisement (e.g., advertising category, script, chain). It also uploads an advertisement file to a file server, moves an advertisement through an approval process (i.e., copywriting, editor approval, producer assignment, voice talent, sound engineering, producer approval, and final approval), and manages advertisement files on the file server.

In a further embodiment, scheduling center 114 schedules advertisements to contracts. In particular, it associates advertisements with in-store or revenue contracts, sets logging capabilities for contract advertisements, sets “stop playing” capabilities for contract advertisements, creates an advertisement schedule for a contract (e.g., assigning dates, slots, stores, etc.), checks schedules for conflicts, and views an advertisement schedule for a contract. By way of example, a playlist includes a media component (e.g., a music playlist) and an advertising component (e.g., an advertisement playlist). The scheduling center 114 manages the advertising component of the playlist.

Reports 115 are one or more tools to view business reports, such as connectivity and scheduling reports. Reports 115 communicate with web application(s) 98 of server(s) 90 via HTTP. Examples of reports include connectivity reports, scheduling reports, billing reports, advertisement reports, sales reports, database sync reports, and the like. Connectivity reports include, for example, success update status reports (lists of client player computer devices that have successfully completed their scheduled update), failed update status reports (lists of client player computer devices that have completed a connection to the server but have not completed their schedule update), and failed physical connections reports (lists of client player computer devices that did not connection to the server at the scheduled time). Scheduling reports include, for example, advertisement schedule reports (schedule information for a specific advertisement), store schedule reports (schedule information for a specific store), and the like. Billing reports include, for example, proof-of-play report for in-store and/or revenue advertisements, billing statements and/or invoices for advertising clients, notices of credit card use for advertising clients, etc. Advertisement reports include advertisement frequency reports (e.g., how often an advertisers advertisement was played during a period of time), advertisement summary reports (e.g., summary information for the advertisement, such as the date recorded, the broadcast schedule, any problems, etc.), final approval reports (e.g., a list of advertisements that require final approval), a report of advertisements that were scheduled but were not broadcast, an advertisement schedule report, a revenue advertisement status report (e.g., shows where they are in the advertisement lifecycle), a report of scheduled advertisements by region (e.g., identifying scheduled advertisements by groups), and the like. Sales reports include, for example, salesman reports (identifies contract amounts, commissions due, monies paid, and residuals for each company, sales person, etc.), monthly sales reports (identifying the number of advertisements provided, the various clients, when advertisements were played, how much the clients have paid, the commission for the sales person(s), the percentage of what is left on the store chain, etc.), reports of contracts with no advertisements (identifying the contracts that have no advertisements associated with them), contract drill-down reports (identifying contracts based on a defined criteria with an option to drill-down to the contract detail), etc. Database sync reports include, for example, complete information reports, which display information relating to which stores have complete connection information and other relevant information as a result of the sync.

Music library manager 116 is a tool to create and maintain media files and genre information, to upload media files to related genre folders, and to define music library versions. Music library manager 116 communicates with application(s) 98 of server(s) 90 via HTTP.

In one embodiment, music library manager 116 manages media files and genre classifications by creating, editing, and/or deleting media information, and/or genre information. It also uploads media files into genre folders, removes silent frames from media files, populates header tags for media files, and/or creates music library versions.

Database sync 117 is a tool that is used to synchronize a chain store repository and data store 95. Database sync 117 communicates with business object(s) 96 of server(s) 90 via RMI and with data store 95 of server(s) 90 via JDBC. In one embodiment, database sync 117 updates store information on the enterprise with information from chain databases. On a scheduled basis, the application establishes database connections, locks records, and updates database records in the enterprise databases. It also reports database synchronization status.

Field support application(s) 118 is a tool to maintain client players, such as client player 80, including viewing reports (e.g., installation histories), managing trouble tickets associated with installations, performing connectivity testing, and the like. Field support application(s) 118 communicates with applications(s) 98 of server(s) 90 via HTTP.

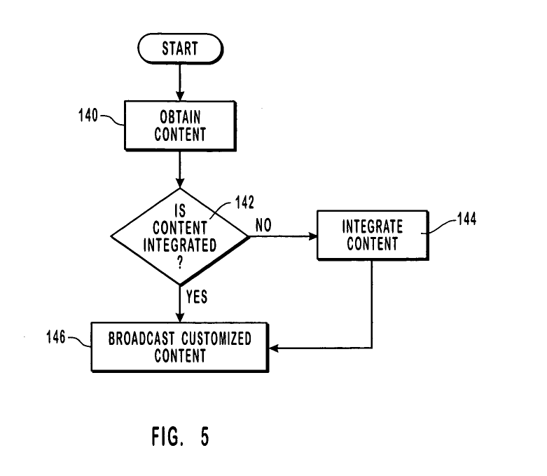

With reference now to FIG. 5, a flowchart is provided that illustrates obtaining customizable content and broadcasting the customized content at a business location. In FIG. 5, execution begins at step 140, wherein customizable media content is obtained. At decision block 142, a determination is made as to whether or not the broadcast content (e.g., music and/or advertisements) is integrated. If it is determined at decision block 142 that the content is not integrated, execution proceeds to step 144 and then to step 146. Alternatively, if it is determined at decision block 142 that the content is integrated, execution proceeds directly to step 146. At step 146, the customized content is broadcast at the business location.

With reference back to step 140, customizable media content may be obtained in a variety of manners. Thus, while the embodiments illustrated in FIGS. 2-4 are representative embodiments that allow for a customizable in-store media broadcast, embodiments of the present invention embrace a variety of different methods, techniques, processes, architectures, and/or system configurations for obtaining customizable content for use in providing an in-store media broadcast. The following is a discussion of a variety of representative techniques that allow for customizable content to be obtained as illustrated at step 140.

For example, one representative embodiment for obtaining content relates to computer devices, such as computer device 10 of FIG. 1, which utilize a peer-to-peer architecture to obtain customizable content, illustrated as step 140 of FIG. 5. The peer-to-peer architecture provides a structure for decentralized music and advertisement management. In the present embodiment, the peer-to-peer process makes it easier to find and share resources on a network, wherein the resources are at least some of the customizable content that may be selectively broadcast at a business location.

In the present embodiment, each peer may be any type of a computer device, such as a personal computer, a laptop computer, an embedded processor, a cell phone, a personal digital assistant, or another computer device. The peers do not depend on a central server. The peer-to-peer application and service provides enhanced access to the network resources while maintaining a high degree of security. At least some embodiments of the present invention embrace obtaining broadcast content using such peer-to-peer file/resource sharing applications as LimeWire, WinMX, Flubster, OpenNap, Morpheus, a proprietary application, or the like.

In a further embodiment, specialized client software is provided to create a peer-to-peer virtual private network between all in-store broadcasting clients and stores. Music and advertisement or other content is shared between clients, eliminating the scalability issues and single point of failure that may be associated with a central server providing audio content and control data. New content is placed on the network and existing content is shared between the peers. The peers do not require a dedicated connection. In some embodiments, the peers periodically connect over a dialup connection to an internet service provider. In order to control the audio that a peer will play, one or more control services provide play list information to each peer. In addition to the control service, a lease service selectively disables the peers when appropriate.

In some embodiments, the peer-to-peer architecture is a subset of a group of stores that utilize the in-store broadcasting, and provides increased intelligence. For example, a peer looks for another peer that is providing information on what should be broadcast and it looks for the content (e.g., a song, advertisement, etc.) within the network. Once located, the content is downloaded, streamed, or obtained in another manner for utilization.

Another representative embodiment for obtaining content relates to computer devices, such as computer device 10 of FIG. 1, which utilize a polling process to obtain customizable content, illustrated as step 140 of FIG. 5. The polling process keeps client devices current, or otherwise up to date, and utilizes protocols other than JDBC and FTP as provided above. Thus, in one embodiment a custom protocol utilizes polling or a heart beat technique to keep the clients up to date. Either a client or a server initiates the polling to determine if an update is needed. The connection between the server(s) and client(s) is kept open or established/torn down between each poll. As loads on servers and the number of clients fluctuate, the time between updates can fluctuate also.

Another representative embodiment for obtaining content relates to computer devices, such as computer device 10 of FIG. 1, which utilize an internet radio appliance to obtain customizable content, illustrated as step 140 of FIG. 5. An internet radio appliance and a dialup connection selectively obtain a customizable music and/or advertisement stream. Thus, in at least some embodiments, low cost equipment is used to receive streaming audio over a dialup connection. One such product is currently known as “Penguin Radio” and is available from PenguinRadio, Inc., which is located at 6447 Randle Avenue, Chesapeake Beach, Md., 20732. (see also http://www.penguinradio.com/penguin) In accordance with an embodiment of the present invention, the product is utilized by a business location to obtain a music and advertisement stream from the internet in order to obtain the customizable content for the in-store broadcast.

Another representative embodiment for obtaining content relates to utilizing a private radio frequency to obtain customizable content, illustrated as step 140 of FIG. 5. The utilization of the private radio frequency allows for an effective manner to obtain the customizable content for the in-store broadcast in at least some markets without running into interference problems.

Thus, in some embodiments, existing radio communication infrastructures are leveraged to establish a private radio frequency. For example, partnerships are formed with existing radio stations that already have a broadcasting infrastructure. One or more private radio frequencies are established that can be used to broadcast advertisement and music content into stores. In a further embodiment, spread spectrum technology is applied at the bandwidths to allow for coexistence.

Another representative embodiment for obtaining content relates to computer devices, such as computer device 10 of FIG. 1, which utilize a streaming satellite transmission to obtain customizable content, illustrated as step 140 of FIG. 5. Using a satellite service, such as DirecTV®, StarBand®, Skycastersg or similar satellite service, any business location can receive customizable music and advertisement content that is streamed directly to the business location.

Another representative embodiment for obtaining content relates to receivers that utilize a satellite audio fee with a separate data channel to obtain customizable content, illustrated as step 140 of FIG. 5. Accordingly, the music content is obtained through the use of an audio channel and the advertisements are obtained on a separate data channel. Since the content is not integrated, the music and advertisements are then selectively mixed at the business location, as represented by step 144 of FIG. 5. Accordingly, the satellite feed provides a wide selection of music for use in in-store broadcasts. In at least one embodiment, the music is organized so that a business can choose between different genres or seasonal categories based on their needs. In addition to the music feeds, the satellite provides a data link that provides custom advertisement content and control data for the business location. At each business, a computer device (such as computer device 10 of FIG. 1) with specialized client software mixes the audio feed with the custom content from the data link (represented by step 144 of FIG. 5). In one embodiment, the computer device performs the mixing based on control data received, wherein the control data specifies what advertisement to play for the broadcast. In one embodiment, the control data is provided at the business location. In another embodiment, the control data is provided from another location. For instance, a store may want to play a specific advertisement every 20 minutes. The advertisement would then be downloaded/received (e.g., through streaming content, etc.) by the computer device in advance of the broadcast. At the particular interval, the volume of the background music is automatically reduced and the advertisement is played. After the advertisement is play the music volume returns to the original levels.

Another representative embodiment for obtaining content relates to utilizing a music compact disks and interjecting custom advertisements to obtain customizable content, illustrated as step 140 of FIG. 5. Music on a storage medium, such as music on a compact disk or other medium, provides background music. Specialized client software is utilized to interject customized advertisements. The software mixes audio content from any music compact disk and a compact disk of custom content (e.g., advertisements). At a given instant in time, such as at the end of a song, one or more advertisements from the custom content is played. The user interface for the software allows a store to determine the order of the music and the customized content. In further embodiments, add-on services include advertisement creation and/or technical support.

Another representative embodiment for obtaining content relates to locally distributing storage media, such as compact disks, IPods, memory sticks, or the like to obtain customizable content, illustrated as step 140 of FIG. 5. Accordingly, strategic partnerships are established to distribute one or more compact disks, IPods, or memory sticks to business locations. In a further embodiment, the strategic partnerships are established with local services in a given region to distribute the compact disks, IPods, or memory sticks to business locations in the region. Accordingly, fresh content is provided on a regular basis to the business locations, and a faster turn around of content is provided as well as help with technical support issues.

Another representative embodiment for obtaining content relates to utilizing a radio broadcast and interjecting custom advertisements to obtain customizable content, illustrated as step 140 of FIG. 5. The radio broadcast provides background music and specialized client software selectively interjects advertisement (referenced as step 144 of FIG. 5). In at least some embodiments, a personal digital assistant (“PDA”) or other computer device is utilized to provide in-store broadcasting by mixing a radio broadcast with custom content from a compact disk or other source. Specialized software for the PDA is written to the control mixing of the two audio sources. The software user interface allows the customized content to be played at specific intervals, or whenever desired. Alternatively, the customized content is downloaded by the PDA via a dialup connection. In at least some embodiments, the software product is installed and managed by a store and any advertisement creation services for the custom content.

Another representative embodiment for obtaining content relates to directly mailing a storage medium (e.g., a CD-R, a CD-RW, or other medium) to each business to obtain customizable content, illustrated as step 140 of FIG. 5. Accordingly, on a periodic basis (e.g., daily, weekly, monthly, etc.) CD-R(s) or CD-RW(s) are directly mailed to the business for use in the in-store broadcast. The CD(s) contain both the advertising content and music content for the specific period. This technology is particularly comfortable to the end user as a large number of individuals are familiar with using a compact disk. In at least some embodiments, all that is required on the customer site is a CD player connected to a sound system at the business location. The straightforwardness of the end customer equipment requirements keep the maintenance and support costs down.

Another representative embodiment for obtaining content relates to using Apple IPods® to obtain customizable content, illustrated as step 140 of FIG. 5. Similar to the embodiment of directly mailing CDRW(s) on a periodic basis, an Apple IPod® system is direct mailed to the business. The IPods® contain the advertising and music mix for the broadcast period. In some embodiments, play statistics are captured on the IPod® memory. In some embodiments, the IPods® are be cross-shipped so that statistics from the specific broadcast period are be captured and stored. Cross shipping of the IPods® further allow for the reuse of the IPods. A mechanism such as a web server allows for the business manager to view the statistics.

Another representative embodiment for obtaining content relates to using memory sticks to obtain customizable content, illustrated as step 140 of FIG. 5. This embodiment is a variation of the embodiments whereby CDs or IPods are provided. However, memory sticks are able to store the music and advertisement content.

Accordingly, as provided herein, embodiments of the present invention embrace a variety of different methods, techniques, processes, architectures, and/or system configurations for obtaining customizable content for use in providing an in-store media broadcast. Those skilled in the art will appreciate that the embodiments provided herein are representative examples of the broad array of manners for providing an in-store media broadcast in accordance with embodiments of the present invention.

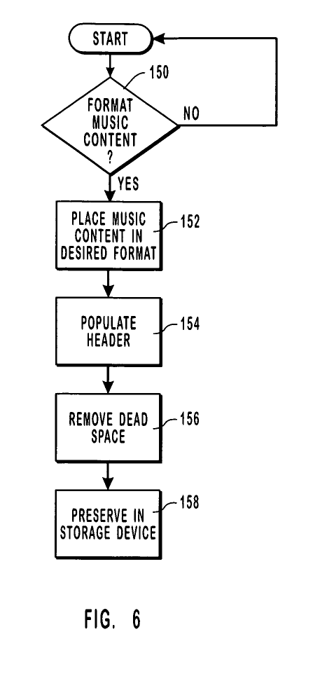

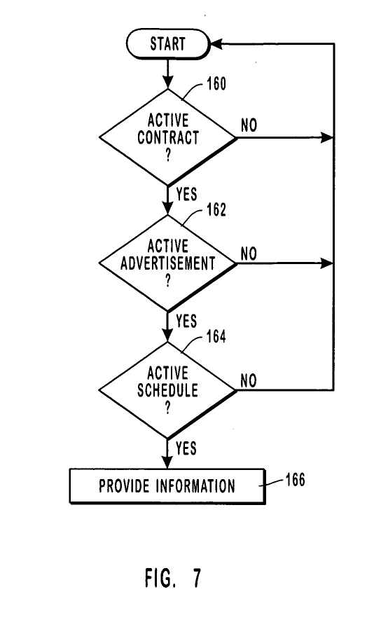

As provided herein, at least some of the embodiments of the present invention relate to formatting broadcast content. Accordingly, FIG. 6 is a flowchart that provides representative processing relating to formatting broadcast content. By way of example, FIGS. 6-7 are provided to illustrate representative processing respectively performed, for example, at music library manager 116 and scheduling center 114 of FIG. 3. In FIG. 6, execution begins at decision block 150 for a determination as to whether or not to format music content. If it is determined at decision block 150 that music content is not to be formatted, execution returns back to start. Alternatively, if it determined at decision block 150 that music content is to be formatted, execution proceeds to step 152, where the music is placed into a desired format. For example, the music content may be received in a “.wav” format and accordingly is ripped into an MP3 format. At step 154, a header is populated and dead space is removed at step 156. The music content is then preserved at step 158 and execution returns back to start.

The scheduling center 114 creates advertising playlists. FIG. 7 displays the process for determining when an advertising playlist is complete and can therefore be transmitted or otherwise proved. In FIG. 7, execution begins at decision block 160 for a determination as to whether or not an active contract had been obtained for a particular block of time. If an active contract has not been obtained, execution returns back to start. Alternatively, if an active contract has been obtained, execution proceeds to decision block 162 for a determination as to whether or not an active advertisement corresponding to the contract has been obtained. Thus, if it is determined at decision block 162 that an active advertisement has not been obtained, execution returns back to start.

Alternatively, if it is determined at decision block 162 that an active advertisement corresponding to the active contract of decision block 160 has been obtained, execution proceeds to decision block 164 for a determination as to whether or not an active schedule corresponding to the advertisement and contract has been obtained. If it is determined at decision block 164 that an active schedule has not been obtained, execution returns back to start. However, if it is determined at decision block 164 that an active schedule that corresponds to the advertisement contract has been obtained, execution proceeds to step 166 to allow an advertising playlist to be provided to a client.

By way of example, and with reference back to FIG. 3, the illustrated embodiment also comprises chain manager 100, which includes music manager 102 and player manager 104. Embodiments of the present invention embrace configurations where both the music manager and the player manager reside on the same computer device, or where the music manager and the player manager reside on multiple computer devices. Music manager 102 is a tool that creates and maintains default and date/time sensitive music playlists for groups and stores in a chain, or an association of client players. Music manager 102 communicates with business object(s) 96 of server(s) 90. In one embodiment, the music manager is used by an employee of a retail chain or another user to manage playlists by creating, editing and/or deleting a default music playlist and/or a date/time specific music playlist. It further assigns stores to a playlist.

Player manager 104 is a tool that controls specific aspects of a client player, including starting or stopping the player, starting or stopping advertisements, moving or skipping media files, launching the client updater, managing error logs, and/or programming the volume of a broadcast. Player manager 104 further views advertisement and media files that are scheduled to play or have already played. Player manager 104 communicates with player 82 of client player 80 via XML-RPC.

In one embodiment, player manager 104 is used by an employee of a retail chain or another user to manage client player computers by displaying information relating to advertisements played, advertisements scheduled, log entries, songs that have played and when they played, etc. It also allows the user to delete log entries, get and/or set the volume of a broadcast, stop scheduled advertisements, skip a currently playing media file, move a media file to a different genre, delete a media file, launch the updater 84, start player 82 (if the player is listening for requests), stop player 82 (leaving the player to listen for requests), selectively shut down the box with a reboot, query the status of the player, and the like.

Thus, as discussed herein, embodiments of the present invention relate to providing a customizable in-store media broadcast. In particular, the present invention relates to systems and methods for providing customizable music, advertisements and/or other content to a remote business or retail location. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A method for providing an in-store media broadcast at a remote location, the method comprising:
obtaining content for a broadcast at the remote location, wherein the broadcast includes music content and one or more advertisements, and wherein the broadcast is customizable to the remote location;
determining whether any content of the broadcast is to be manipulated at the remote location; and
executing at least a portion of a broadcast schedule of the broadcast at the remote location.

2. A method as recited in claim 1, further comprising a step for manipulating any content of the broadcast determined to be manipulated at the remote location.

3. A method as recited in claim 2, wherein the step for manipulating any content of the broadcast determined to be manipulated at the remote location comprises integrating music content with one or more advertisements.

4. A method as recited in claim 1, wherein the step for obtaining content for the broadcast at the remote location comprises a step for using a peer-to-peer architecture to obtain at least one of (i) music content and (ii) an advertisement.

5. A method as recited in claim 4, further comprising a step for using client software to provide a private network between in-store broadcasting clients.

6. A method as recited in claim 5, further comprising steps for:
providing usable content on the private network; and
sharing the usable content between the broadcasting clients.

7. A method as recited in claim 6, wherein the step for sharing the usable content between the broadcasting clients comprises a step for periodically using a dialup connection.

8. A method as recited in claim 6, further comprising a step for receiving play list information at each client.

9. A method as recited in claim 1, wherein the step for obtaining content for a broadcast at the remote location includes using a polling process.

10. A method as recited in claim 9, wherein the polling process includes a custom protocol.

11. A method as recited in claim 9, wherein the polling process is initiated by one of (i) a client computer device and (ii) a server computer device.

12. A method as recited in claim 1, wherein the step for obtaining content for a broadcast at the remote location comprises a step for using an internet radio device.

13. A method as recited in claim 12, wherein the internet radio device utilizes a dialup connection to receive streaming audio.

14. A method as recited in claim 1, wherein the step for obtaining content for a broadcast at the remote location comprises a step for using a radio frequency.

15. A method as recited in claim 14, wherein the step for using a radio frequency comprises a step for leveraging an existing radio communication infrastructure to establish the radio frequency, and wherein the radio frequency is a private radio frequency.

16. A method as recited in claim 15, further comprising a step for using a spread spectrum technology in association with the radio frequency.

17. A method as recited in claim 1, wherein the step for obtaining content for a broadcast at the remote location comprises a step for using a streaming satellite transmission.

18. A method as recited in claim 1, wherein the step for obtaining content for a broadcast at the remote location comprises a step for using a satellite audio feed and a separate data channel.

19. A method as recited in claim 18, wherein the audio channel is used to obtain the music content and the data channel is used to obtain the one or more advertisements.

20. A method as recited in claim 19, wherein the step for determining whether any content of the broadcast is to be manipulated at the remote location comprises a step for mixing the music content and the one or more advertisements at the remote location.

21. A method as recited in claim 1, wherein the step for obtaining content for a broadcast at the remote location includes identifying a particular music genres for the broadcast.

22. A method as recited in claim 1, wherein the step for obtaining content for a broadcast at the remote location comprises a step for receiving a storage medium that includes the content obtained for the broadcast.

23. A method as recited in claim 22, wherein the storage medium is one of:
(i) a compact disk;
(ii) an IPod®; and
(iii) a memory stick.

24. A method as recited in claim 23, wherein the compact disk is a commercial music compact disk that provides background music, and wherein the method further includes a step for using a software application to selectively interject the one or more advertisements into the broadcast.

25. A method as recited in claim 23, wherein the storage medium is delivered within a particular region from a provider local to the remote location.

26. A method as recited in claim 23, wherein the storage medium is delivered through an express courier service.

27. A method as recited in claim 23, wherein the storage medium includes at least one of (i) the music content and (ii) the one or more advertisements.

28. A method as recited in claim 1, further comprising a step for reporting execution of the broadcast at the remote location.

29. A method as recited in claim 1, wherein the step for obtaining content for a broadcast at the remote location comprises a step for using a radio broadcast to provide the music content and a client software to interject the one or more advertisements.

30. A customizable in-store media broadcast delivery system comprising:
a source location that selectively provides content for a broadcast at a remote location, wherein the broadcast includes music content and one or more advertisements, and wherein the broadcast is customizable to the remote location;
a mechanism for delivery of the content from the source location to the remote location; and
the remote location that receives the content for the broadcast from the source location, determines whether any content of the broadcast is to be manipulated at the remote location, and executes at least a portion of a broadcast schedule of the broadcast at the remote location.

31. A customizable in-store media broadcast delivery system as recited in claim 30, wherein the mechanism comprises at least one of:
(i) a peer-to-peer architecture;
(ii) a polling process;
(iii) an internet radio appliance;
(iv) a radio frequency;
(v) a streaming satellite transmission;
(vi) a satellite audio feed with a separate data channel;
(vii) a storage medium; and
(viii) a radio broadcast.

32. A computer program product for implementing within a computer system a method for providing a customizable an in-store media broadcast at a remote location, the computer program product comprising:
a computer readable medium for providing computer program code means utilized to implement the method, wherein the computer program code means is comprised of executable code for implementing the steps for:
obtaining content for a broadcast at the remote location, wherein the broadcast includes music content and one or more advertisements, and wherein the broadcast is customizable to the remote location;
determining whether any content of the broadcast is to be manipulated at the remote location; and
executing at least a portion of a broadcast schedule of the broadcast at the remote location.

33. A computer program product as recited in claim 32, wherein the computer program code means is further comprised of executable code for implementing a step for manipulating any content of the broadcast determined to be manipulated at the remote location.

34. A computer program product as recited in claim 33, wherein the step for manipulating any content of the broadcast determined to be manipulated at the remote location comprises dynamically integrating music content with one or more advertisements.

35. A computer program product as recited in claim 32, wherein the step for obtaining content for the broadcast at the remote location comprises a step for using a peer-to-peer architecture to obtain at least one of (i) music content and (ii) an advertisement.

36. A computer program product as recited in claim 35, wherein the computer program code means is further comprised of executable code for implementing steps for:
providing usable content on a private network; and
sharing the usable content between broadcasting clients.

37. A computer program product as recited in claim 32, wherein the step for obtaining content for a broadcast at the remote location includes at least one of:
(i) using a polling process;
(ii) using an internet radio device;
(iii) using a streaming satellite transmission;
(iv) using a satellite audio feed and a separate data channel; and
(v) obtaining the content for the broadcast from a storage medium delivered to the remote location.

38. A computer program product as recited in claim 37, wherein the storage medium is one of:
(i) a compact disk;
(ii) an IPod®; and
(iii) a memory stick.

39. A computer program product as recited in claim 32, wherein the computer program code means is further comprised of executable code for implementing a step for reporting execution of the broadcast at the remote location.
